(19) United States
(12) Patent Application Publication
(10) Pub. No.: US 2013/0243002 A1
(43) Pub. Date: Sep. 19, 2013

(54) METHOD AND APPARATUS FOR MITIGATING EFFECTS OF SCHEDULING DELAYS IN HOLD TIMER EXPIRY

(71) Applicant: Saurabh Shrivastava, Sunnyvale, CA (US)

(72) Inventor: Saurabh Shrivastava, Sunnyvale, CA (US)

(21) Appl. No.: 13/423,461

(22) Filed: Mar. 19, 2012

(51) Int. Cl. H04L 12/56

(52) U.S. Cl. 370/401

(57) ABSTRACT

A method, apparatus and system for processing control packets in a routing device by comparing the timestamp of the received packets to an expiry time associated with a first neighbor node in a suspended animation (SA) list and in response to the timestamp being more than the expiry time, removing all the neighbor nodes having an expiry time less than that of the timestamp.

### FIELD OF THE INVENTION

The invention relates to the field of communication networks and, more specifically, to traffic management in such networks using granular policing.

### BACKGROUND

Within the context of high-capacity data routing devices and switches, packets received by a routing device or switch may comprise data packets or control (protocol) packets. All packets are subjected to buffering, queuing and other temporary storage operations within the routing device or switch.

Protocol packets arriving at a control processor of a router control card are typically buffered first by general purpose hardware/input buffers and then by appropriate software buffers as they become available; the software buffers being associated with corresponding control processor queues. The protocol packets are then processed by one or more software modules, each of the different software module typically being associated with a respective input queue. Each of the software modules is allocated a time slice by the operating system within which the portion of the queued protocol packets associated with the software module are to be processed.

While the allocated time slice may be sufficient to process some or even all of the queued protocol packets, the buffering, queuing and time slice processing of control or protocol packets introduces non-determinism with respect to the ultimate time for processing of such packets. In particular, it is difficult to determine the time at which the final software module intended to consume a buffer or queue will actually process the control or protocol packets within that buffer or queue.

Timely processing of control or protocol packet is critical in many areas. For example, the Intermediate System-to-Intermediate System (ISIS) protocol is a routing protocol used to exchange information between routing devices. This protocol allows devices to advertise their liveliness using “hello” packets at predefined intervals (typically hundreds of milliseconds to a few seconds), where failure to advertise liveliness to a neighbor is interpreted by the ISIS protocol of the neighbor as a device fail or device dead condition.

Presently, to avoid this condition, routers and switching devices employ brute force methods such as high-speed processors and the like to ensure that control/protocol packets are timely processed. This approach is expensive and inefficient.

### BRIEF SUMMARY

Various deficiencies in the prior art are addressed through the invention of a method, apparatus and system for processing control packets in a routing device, comprising: receiving a control packet having associated with it a timestamp; comparing the timestamp of the received packets to an expiry time associated with a first neighbor node in a suspended animation (SA) list; and in response to the timestamp being more than the expiry time, removing all the neighbor nodes having an expiry time less than that of the timestamp.

Various embodiments may further comprise in response to the timestamp being greater than the expiry time, leaving the first neighbor node in the suspended animation list. Various embodiments may further comprise reviving a liveliness parameters associated with all the that first neighbor nodes removed from the suspended animation list.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an apparatus benefiting from embodiments of the present invention;

FIG. 2 depicts a flow diagram of the operation of an ISIS expiry routine operable at each of a plurality of neighboring nodes using the ISIS routing protocol; and

FIG. 3 depicts a flow diagram of a method for processing received control packets to reduce incorrect determinations associated with neighboring node liveliness.

To facilitate understanding, identical reference numerals have been used, where possible, to designate identical elements that are common to the figures.

### DETAILED DESCRIPTION OF THE INVENTION

The invention will be primarily described within the context of a router; however, those skilled in the art and informed by the teachings herein will realize that the invention is also applicable to any network device that must receive and process time-sensitive control packets such as “hello packets, “keep alive” packets and the like as used by various protocols.

Various embodiments address the processing of critical protocol packets where such packets may not have been timely processed by a control plane processor, such as due to packet buffering/packet queue architecture or processing characteristics. The various embodiments may identify improper decisions associated with delayed processing of control packets and responsively modify of the control processor introduces the possibility of untimely processing (e.g., a delay in processing a “hello” message from a neighboring network entity may result in a false determination that the entity is not alive). This problem may be exacerbated by DoS attack or other control plane resource loading.

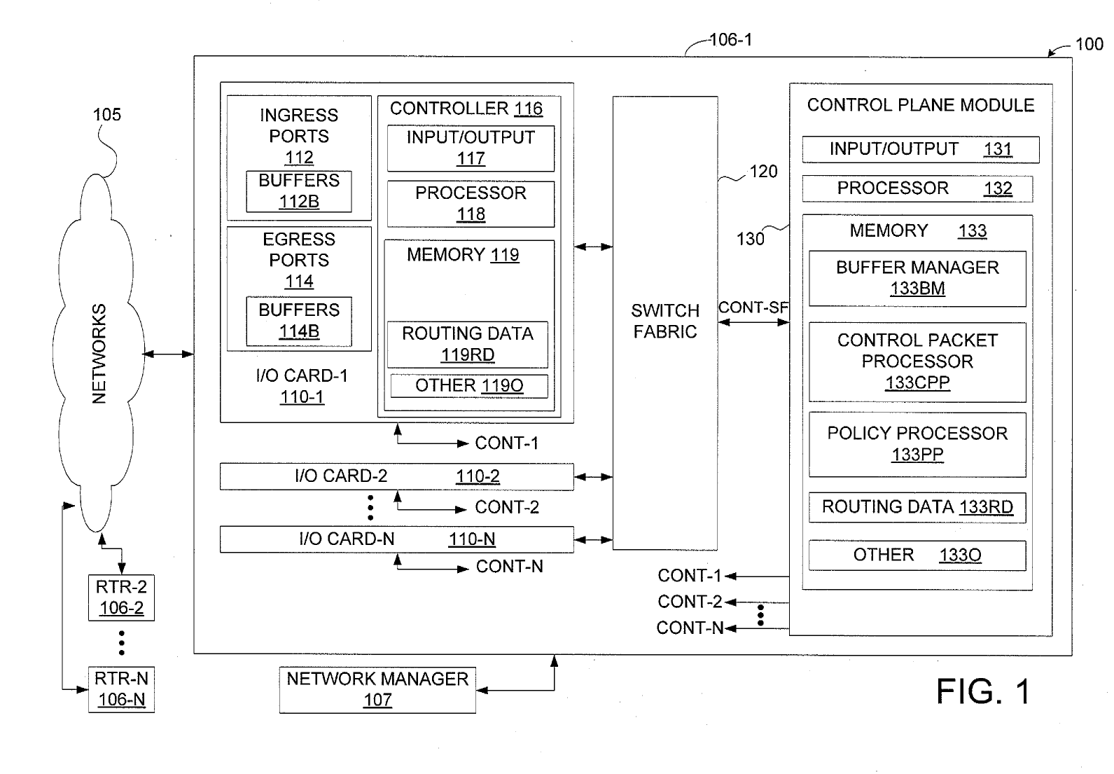

FIG. 1 depicts a high-level block diagram of an apparatus benefiting from embodiments of the present invention. Specifically, FIG. 1 depicts a plurality of routers denoted as 106-1, 106-2 through 106-N in communication with each other via a network 105. For purposes of this discussion, it is assumed that at least some of the routers 106 are neighbors with respect to each other and, therefore, send routing protocol signals to each other such as ISIS “hello” packets and the like.

The instant discussion will focus on router 106-1, which is depicted as communicating with the network 105 and a network manager 107. The router 106-1 as depicted includes a plurality of input output (I/O) cards 110-1, 110-2 and so on up to 110-N (collectively I/O cards 110), a switch fabric 120 and a control plane module 130. The control plane module 130 controls the operation of the I/O cards 110 and switch fabric 120 by respective control signals CONT.

Each of the I/O cards 110 includes a plurality of ingress ports 112 including corresponding ingress port buffers 112B, a plurality of egress ports 114 including corresponding egress port buffers 114B, and a controller 116 including an I/O module 117, a processor 118 and memory 119. The memory 119 is depicted as including software modules, instantiated objects and the like to provide routing data functions 119RD and other functions 119O. The controller 116 may be implemented as a general purpose computing device or specific purpose computing device.

The I/O cards 110 operate to convey packets between the network 105 and the switch fabric 120. Packets received at a particular ingress port 112 of an I/O card 110 may be conveyed to the switch fabric 120 or back to the network 105 via a particular egress port 112 of the I/O cards 110. Routing of packets via the I/O cards 110 is accomplished in a standard manner according to routing data provided by the control plane module 130, which may be stored in the routing data portion of memory 119.

The switch fabric 120 may comprise any standard switch fabric such as electrical, optical, electro-optical, MEMS and the like.

The control plane module 130 receives from a network manager 107 configuration data, routing data, policy information and other information pertaining to various management functions. The control plane module 130 provides management and operations data to the network manager 107, including data such as configuration data, status data, alarm data, performance data and the like.

The control plane module 130 comprises an I/O module 131, a processor 132 and memory 133. The memory 133 is depicted as including software modules, instantiated objects and the like to provide a buffer manager 133BM, a control packet processor 133CPP, a policy processor 133PP, routing data 133RD and other functions 133O. The control plane module 130 may be implemented as a general purpose computing device or specific purpose computing device.

The buffer manager 133BM operates to manage the buffer structure provided by, illustratively, ingress ports, egress ports, switch fabric and so on. The buffer manager 133BM also interacts with the various buffers to determine whether soft or hard limits have been reached, such as an overutilization warning limit (e.g., 80% of buffer utilization level), an overutilization alarm limit (e.g., 95% of buffer utilization level) and so on of the buffers operative within the context of the router 106-1.

The control packet processor 133CPP operates to process control packets received by the router 106-1, such as routing protocol packets received from neighboring routers, switching elements and other types of nodes. The operations of the control packet processor 133CPP may be guided by policies processed via the policy processor 133PP. Some of the operations of the control packet processor 133CPP will be discussed in more detail below with respect to the various figures.

The policy processor 133PP operates to process policy information such as service level agreement (SLA), traffic classification constraints, subscriber/user constraints, differentiated service levels, differentiated QoS levels/parameters and, generally, any other policy related parameter impacting the number, type, operating parameters and/or other characteristics of the policers to be instantiated within the context of the router 106-1.

The routing data 133RD operates to process routing information such that packets or traffic flows received at ingress ports are routed to appropriate egress ports within the context of the router 106-1. The routing data 133RD may include routing tables, protection or fault recovery information and so on.

The various managers and processors discussed above also operate to monitor and process control plane packets, traffic and protocols. This control plane protocol monitoring and processing function may be implemented by the buffer manager 133BM, control packet processor 133CPP, the policy processor 133PP and/or any other control plane processing element capable of monitoring changes in the behavior of control plane protocol information or traffic.

In one embodiment, the control plane module 130 discussed above with respect to FIG. 1 comprises a general-purpose central processing unit (CPU) operable to process control plane packets and generally defining routing and forwarding operations associated with traffic flows passing through a routing or switching device.

In one embodiment, the control plane module 130 discussed above with respect to FIG. 1 comprises a special purpose control processor (CP) or other processing entity that may be optimized with respect to the general-purpose CPU embodiment. In particular, the CP may be implemented as an array of processing elements that allow distribution of workload within the CP, and by parallel execution of algorithms.

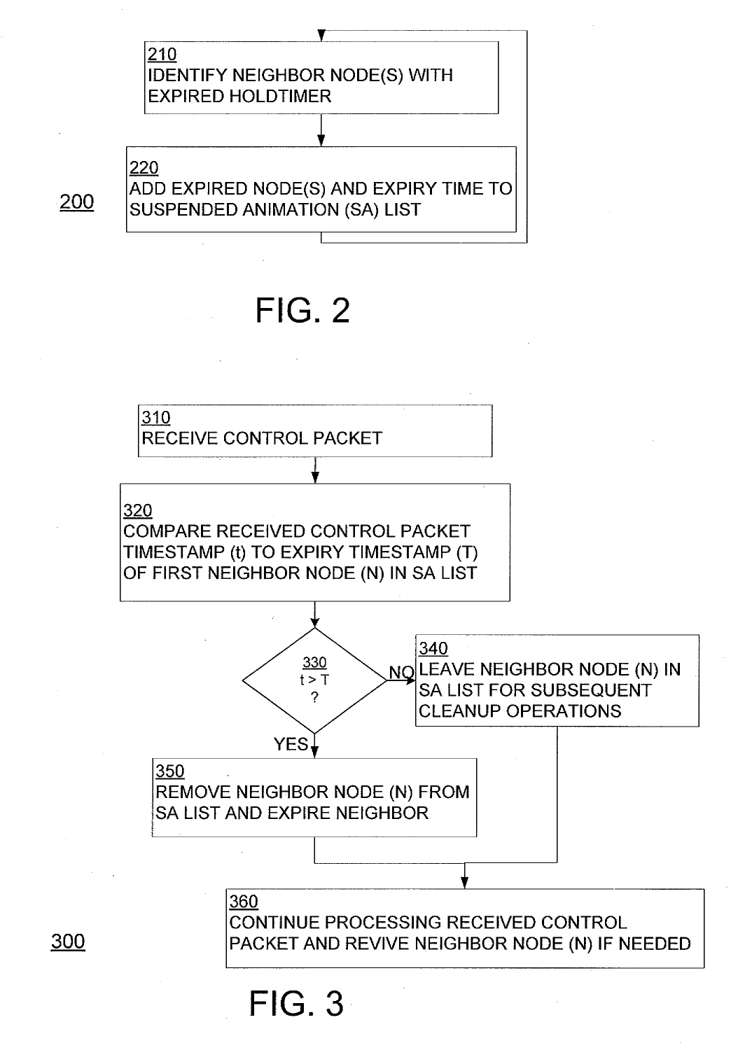

FIG. 2 depicts a flow diagram of the operation of an ISIS expiry routine operable at each of a plurality of neighboring nodes using the ISIS routing protocol. In particular, at step 210, one or more neighboring nodes associated with an expired hold timer are identified, while at step 220 the identification and expiry time associated with the expired node or nodes identified at step 210 is stored in the suspended animation (SA) list.

Specifically, neighboring routing devices are required to advertise to each other the fact that they are alive by transmitting “hello” packets to each other at minimum predetermined time intervals. If a “hello” packet expected from a neighboring node is not processed within the predetermined time interval, then the neighboring node is added to a suspended animation (SA) list. That is, ISIS maintains a SA (suspended animation) list of neighbors whose hold timer has expired (i.e., no “hello” was received in the required interval).

The SA is ordered by the time of expiry of neighbors. For example, if neighbor node A expired at time t=10, and neighbor node B expired at time t=12, neighbor node A will appear before neighbor node B in the SA list. When the hold timer for a neighbor expires, ISIS doesn't start the cleanup process for the neighbor immediately; rather, it puts the neighbor in the SA list, and continues to serve other events such as the arrival of packets from different neighbors.

Table 1 depicts a portion of an exemplary suspended animation (SA) list. In particular, Table 1 depicts a first neighbor node (x.x.10.0) that expired at time T=18, a second neighbor node (x.x.20.0) that expired at time T=19, and a third neighbor node (x.x.30.0) that expired at time T=20.

TABLE 1

| ID Neighbor Node (N) | Expiry Time (T) |
|---|---|
| 222.100.10.0 | 18 |
| 222.100.20.0 | 19 |
| 222.100.30.0 | 20 |

In various embodiments, received control plane packets are timestamped as they are received, such as at the control plane module 130 or at an I/O card 110, such as at an ingress port 112.

Various embodiments address the control packet processing delay problem by determining whether any protocol related control packets were not processed in a timely manner such that a delay-induced problem may have occurred. This determination is made using the time stamps of the control packets. Specifically, if the timestamp of a control packet is such that the control packet should have been processed earlier to avoid an erroneous decision (e.g., a decision determining that a neighboring node is dead), then in one embodiment a process is immediately invoked to correct the erroneous decision rather than waiting for a periodic refresh of the neighboring node that would eventually address the erroneous decision.

FIG. 3 depicts a flow diagram of a method for processing received control packets to reduce incorrect determinations associated with neighboring node liveliness.

At step 310, a control packet is received by, illustratively, a control plane processor of a routing or switching device.

At step 320, the timestamp (t) associated with the received control plane packet is compared to the expiry time (T) associated with the first neighbor node (N) within the suspended animation (SA) list.

At step 330, a query is made as to whether the timestamp (t) associated with the received control plane packet is less than the expiry time (T) associated with the first neighbor node (N) within the suspended animation (SA) list.

If the query at step 330 is entered negatively, then at step 340 the first neighbor node N is left within the SA list for subsequent cleanup operations. If the query at step 330 is answered affirmatively, then at step 350 the first neighbor node (N) is removed from the SA list.

At step 360, the processing of the receives control packet is continued and, if necessary, the first neighbor node (N) is revived. That is, those received control packets that are not associated with nodes included within the SA list are subjected to further processing according to the norms of the relevant protocol (e.g., ISIS or other protocol).

As a first example, and referring to Table 1 and FIG. 3, if a control packet having a timestamp t=17 is received for processing, then the SA list is not adjusted by the method since (in this example) the first node (N) is associated with a “hello” expiry time of T=18. Similarly, if a control packet having a timestamp t=19 is received for processing, then the method removes the first neighbor (N) in the SA list (i.e., 222.100.10.0) because the expiry time of T=18 has passed without receiving a “hello” from this first node. Specifically, the “hello” from this node was due to be received by a time t=18 (in which case this neighbor node would have been revived and would not be in the SA list), but a control packet exhibiting a timestamp t=19 has been received, indicating that that time t=18 has elapsed.

The above-described methodology may be executed at, for example, a control plane module 130, a control processor and/or network processor within a router. The above-described methodology operates to mitigate delay-related errors by checking to see if such an error likely occurred and immediately fixing the error. In this manner, an extremely rapid recovery from delay induced errors is provided which, in turn, provides for a more resilient network since inappropriate or incorrect neighbor node expiry timeouts and subsequent revival operations are avoided or minimized. Delay-type errors may be caused by normal delay related errors (nondeterministic delays characteristic of the architectures used) as well as malicious attacks (e.g., DoS) where additional delay is imparted to the system due to increased processing load and other resource constraining consequences of such an attack.

The various embodiments discussed herein operate in a manner tending to reduce incorrect assignment of neighbor nodes to the SA list by operation of an ISIS expiry routine, which is physically operable at each of a plurality of neighboring nodes using the ISIS routing protocol. It will be appreciated though skill in the art that similar expiry routines used by other routing protocols are also contemplated by the inventors as benefiting from the body and described herein. Thus, the various embodiments discussed above are also applicable to various protocols in which nodes use “hello” or “alive” type messages to detect neighbor node liveness, such as Open Shortest Path First (OSPF), Border Gateway Protocol (BGP) and the like.

The control plane module 130 is generally depicted as a general purpose computer suitable for use in performing the functions described herein. As noted above with respect to FIG. 1, the control plane module 130 comprises an I/O module 131, a processor 132 and memory 133.

The I/O module 131 may be implemented as circuitry adapted to provide communications and general interfacing between the various functional elements of the router 106, the network manager 107, and/or user input/output devices (not shown).

The processor 132 may be implemented as a general purpose or special purpose CPU, a control processor CP and the like.

The memory 133 may be implemented as random access memory (RAM) and/or read only memory (ROM), storage devices, including but not limited to, a tape drive, a floppy drive, a hard disk drive or a compact disk drive.

It will be appreciated that control plane module 130 provides a general architecture and functionality suitable for implementing functional elements described herein and/or portions of functional elements described herein. Functions depicted and described herein may be implemented in software and/or hardware, e.g., using a general purpose computer, one or more application specific integrated circuits (ASIC), and/or any other hardware equivalents.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, transmitted via tangible media and/or stored within a memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for processing control packets in a routing device, comprising:
receiving a control packet having associated with it a timestamp;
comparing the timestamp of the received packets to an expiry time associated with a first neighbor node in a suspended animation (SA) list; and
in response to said timestamp being greater than said expiry time, removing said first neighbor node from the SA list.

2. The method of claim 1, further comprising in response to said timestamp being less than said expiry time, leaving said first neighbor node in the SA list.

3. The method of claim 1, further comprising reviving a liveness parameter associated with the first neighbor node removed from the SA list.

4. The method of claim 1, further comprising subjecting to further processing those received control packets not associated with nodes included within the SA list.

5. The method of claim 1, further comprising adding a node to the SA list in response to a determination that the node is associated with an expired hold timer.

6. The method of claim 1, wherein the control packet is adapted to convey a live state of a neighboring router according to Intermediate System-to-Intermediate System (ISIS) protocol.

7. The method of claim 1, wherein the control packet is adapted to convey a live state of a neighboring router according to Open Shortest Path First (OSPF) protocol.

8. The method of claim 1, wherein the control packet is adapted to convey a live state of a neighboring router according to Border Gateway Protocol (BGP).

9. An control plane processor for processing control packets in a routing device, the control plane processor configured to perform a method comprising:
receiving a control packet having associated with it a timestamp;
comparing the timestamp of the received packets to an expiry time associated with a first neighbor node in a suspended animation (SA) list; and
in response to said timestamp being greater less than said expiry time, removing said first neighbor node from said suspended animation list.

10. The method of claim 9, further comprising in response to said timestamp being less than said expiry time, leaving said first neighbor node in the SA list.

11. The method of claim 9, further comprising reviving a liveness parameter associated with the first neighbor node removed from the SA list.

12. The method of claim 9, further comprising subjecting to further processing those received control packets not associated with nodes included within the SA list.

13. The method of claim 9, further comprising adding a node to the SA list in response to a determination that the node is associated with an expired hold timer.

14. The method of claim 1, wherein the control packet is adapted to convey a live state of a neighboring router according to one of an Intermediate System-to-Intermediate System (ISIS) protocol, an Open Shortest Path First (OSPF) protocol and a Border Gateway Protocol (BGP).

15. A computer readable medium including software instructions which, when executed by a processer, performs a method for processing control packets in a routing device, comprising:
receiving a control packet having associated with it a timestamp;
comparing the timestamp of the received packets to an expiry time associated with a first neighbor node in a suspended animation (SA) list; and
in response to said timestamp being greater less than said expiry time, removing said first neighbor node from said suspended animation list.

16. A computer program product, wherein a computer is operative to process software instructions which adapt the operation of the computer such that computer performs a method for processing control packets in a routing device, comprising:
receiving a control packet having associated with it a timestamp;
comparing the timestamp of the received packets to an expiry time associated with a first neighbor node in a suspended animation (SA) list; and
in response to said timestamp being greater less than said expiry time, removing said first neighbor node from said suspended animation list.
